(19) United States
(12) Patent Application Publication
(10) Pub. No.: US 2003/0089147 A1
(43) Pub. Date: May 15, 2003

(54) DUAL MECHANISM LOCK

(76) Inventor: Ping-Jan Yang, Taipei (TW)

Correspondence Address: Rosenberg Klein & Lee, 3458 Ellicott Center Drive-Suite 101, Ellicott City, MD, 21043, US

(21) Appl. No.: 10/012,447

(22) Filed: Nov. 9, 2001

(51) Int. Cl. E05B 37/00

(52) U.S. Cl. 70/284

(57) ABSTRACT

A dual mechanism lock comprises a combination lock structure is disposed; a key lock having an internal cylinder and an external cylinder, and a fixing plate is embedded into a fixing groove on the external cylinder; the combination lock structure having a plurality of combination wheels pivotally coupled to the lock core rod connecting to the external cylinder; a spring is disposed between the other end of the lock core rod and the lock body; the internal cylinder is protruded from the panel and the panel is coupled to a knob; a sliding member is corresponsive to coupling and detachment of the inner groove of the external cylinder, and the lock core rod and the combination wheels control the coupling and detachment of the fixing plate and the external cylinder, or the key via the internal cylinder generates the movement for the coupling and detachment.

### BACKGROUND OF THE INVENTION

1. Field of the Invention

The present invention relates to a dual mechanism lock, particularly to a lock structure that simultaneously comprising two mechanisms: a combination lock mechanism and a key lock mechanism.

2. Description of the Prior Art

In FIG. 1, a prior-art dual mechanism lock structure comprises a lock body 1a, and the lock body 1a further comprises a combination lock structure 2a and a key lock mechanism 3a, wherein an axle 21a of the combination lock structure 2a directly passes through the key lock 3a, and couples to the lock core 31a such that the coupling and detachment actions can be performed between the axle 21a and the lock core 31. There are difficulties in the manufacturing of such lock, because the lock core of each key lock working together with the combination lock has to be specially made such that its lock core can operate with the combination lock. It makes the structure of the lock core more complicated.

In view of the shortcomings of the prior art mentioned above, which are the subjects of improvements for a long time, hence the inventor of the present invention based on years of experience accumulated from the engagement in the related industry conducted extensive research to provide a more practical lock, resolved the foregoing shortcomings, and invented the present invention.

Therefore, the primary objective of the present invention is to provide a dual mechanism lock comprising a lock body, which simultaneously has two lock mechanisms: a combination lock mechanism and a key lock mechanism. The user just needs a set of numbers for unlocking the combination lock or a key for unlocking the key lock, and thus gives a more convenient way of application. The present invention is characterized in that the combination lock mechanism works together with the fixing plate and produces an indirect control to the lock tongue, and will not influence the key lock mechanism by directly controlling the lock tongue, and working with the recession of the external cylinder of the key lock structure, thereby the rotary motion can accomplish the reset for the combination numbers.

To attain the foregoing purpose, the structure of the present invention comprises a lock body in which a combination lock is disposed; a key lock having an internal cylinder and an external cylinder, and a fixing plate is disposed in the combination lock structure, such that a lateral side of the fixing plate is embedded into a fixing groove on the external cylinder; the combination lock structure having a plurality of combination wheels pivotally coupled to the lock core rod which supports the periphery surface of the external cylinder; a spring is disposed between the other end of the lock core rod and the lock body; each combination wheel is coupled to an elastic latch plate; the lock body is covered by a panel, thereby the internal cylinder is protruded from the panel and the panel is coupled to a knob; the surface of the knob has a keyhole; a sliding member is corresponsive to the coupling and detachment of the inner groove of the external cylinder, and the lock core rod and the combination wheels control the coupling and detachment of the fixing plate and the external cylinder, or the key via the internal cylinder generates the movement for the coupling and detachment, and the external cylinder by itself can release the pressing of the lock core rod, and reset the numbers of the combination wheels.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a front-view diagram of the prior-art structure.

FIG. 2 is a three-dimensional diagram of the present invention.

FIG. 3 shows the disassembled parts of the dual mechanism lock structure of the present invention.

FIG. 4 shows the disassembled parts of the key lock mechanism according to the present invention.

FIG. 4A shows a partial cutaway view of the FIG. 4 after the lock is assembled but it is not in action.

FIG. 4B shows a partial cutaway view of the FIG. 4 after the lock is assembled and is rotated in action.

FIG. 4C shows a partial cutaway view of the FIG. 4 after the lock is assembled and is rotated to bring the internal cylinder in action to move the lock tongue.

FIG. 5 shows the disassembled parts of the combination lock mechanism of the present invention.

FIG. 5A shows the three-dimensional diagram of the lock structure as shown in FIG. 5 after the combination lock is locked.

FIG. 5B shows the three-dimensional diagram of the lock structure as shown in FIG. 5 after the combination lock is unlocked.

FIG. 5C shows the three-dimensional diagram of the lock structure as shown in FIG. 5 when the lock is not locked, and brings the internal cylinder in action to move the lock tongue.

FIG. 6 shows the three-dimensional diagram of the lock structure as shown in FIG. 5 when the numbers of the combination lock is changed.

FIG. 7 shows the three-dimensional diagram of the fixing wheel and the combination wheel of the present invention.

FIG. 7A shows the three-dimensional diagram of the lock core rod as shown in FIG. 7 having an installed protruded member according to the present invention.

FIG. 8A is the schematic diagram showing the mechanism of a single fixing v heel set and lock core rod, and the fixing plate, when it is locked.

FIG. 8B is the schematic diagram showing the mechanism of a single fixing wheel set and lock core rod, and the fixing plate, when it is unlocked.

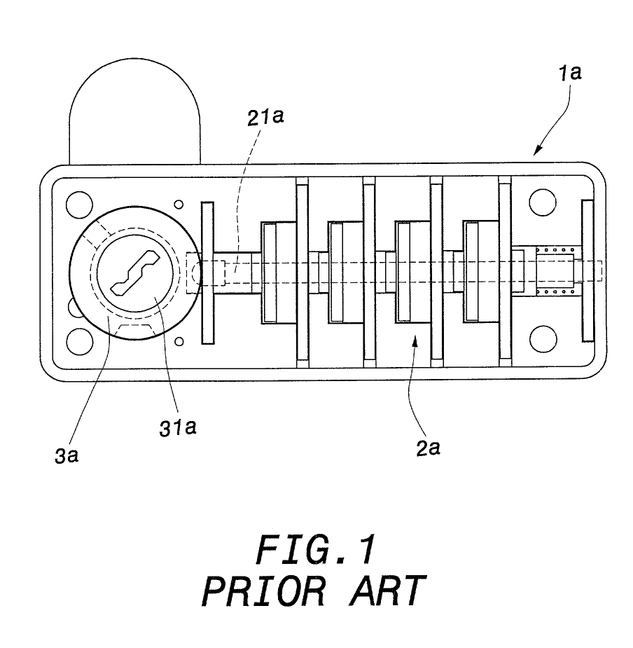

### DESCRIPTION OF THE PREFERRED EMBODIMENT

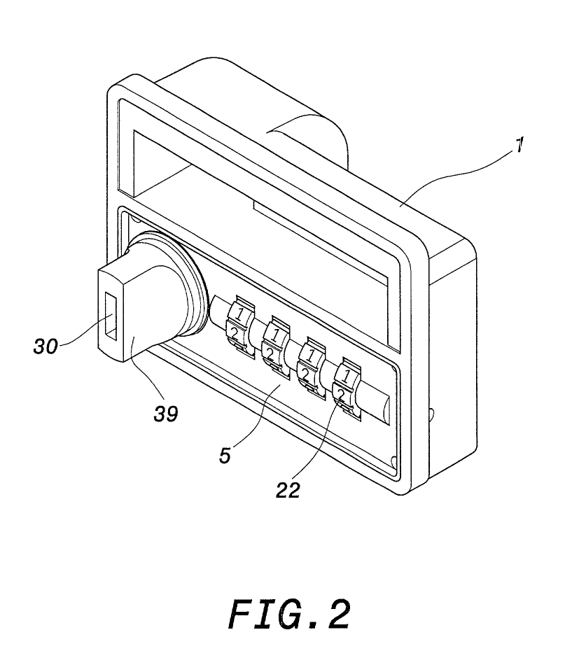

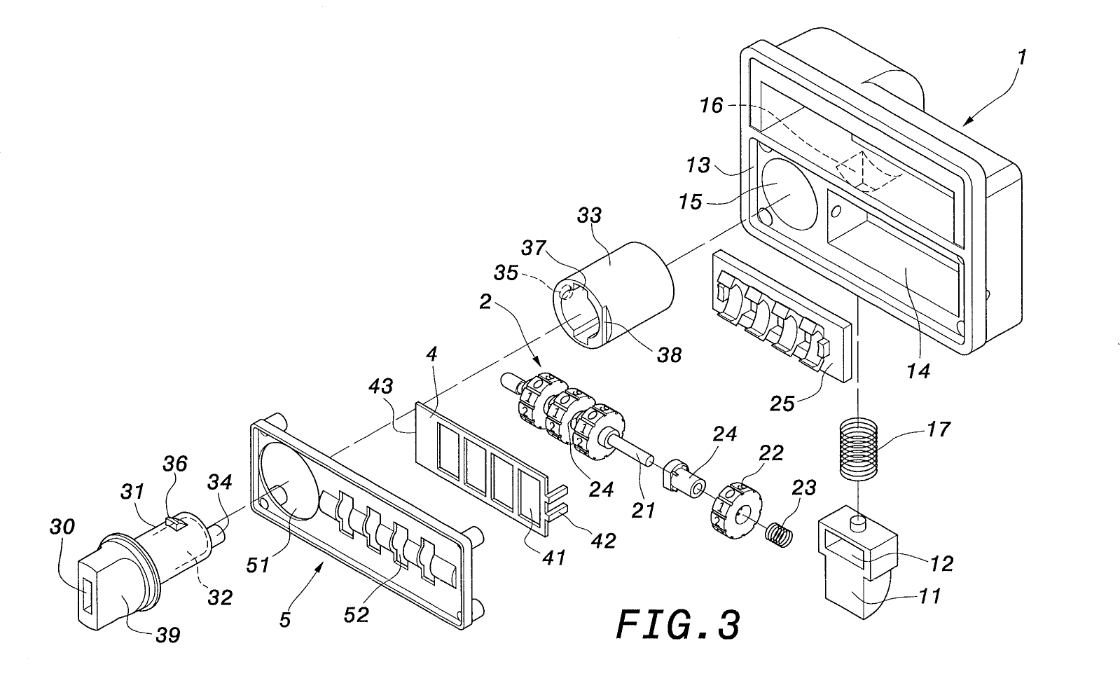

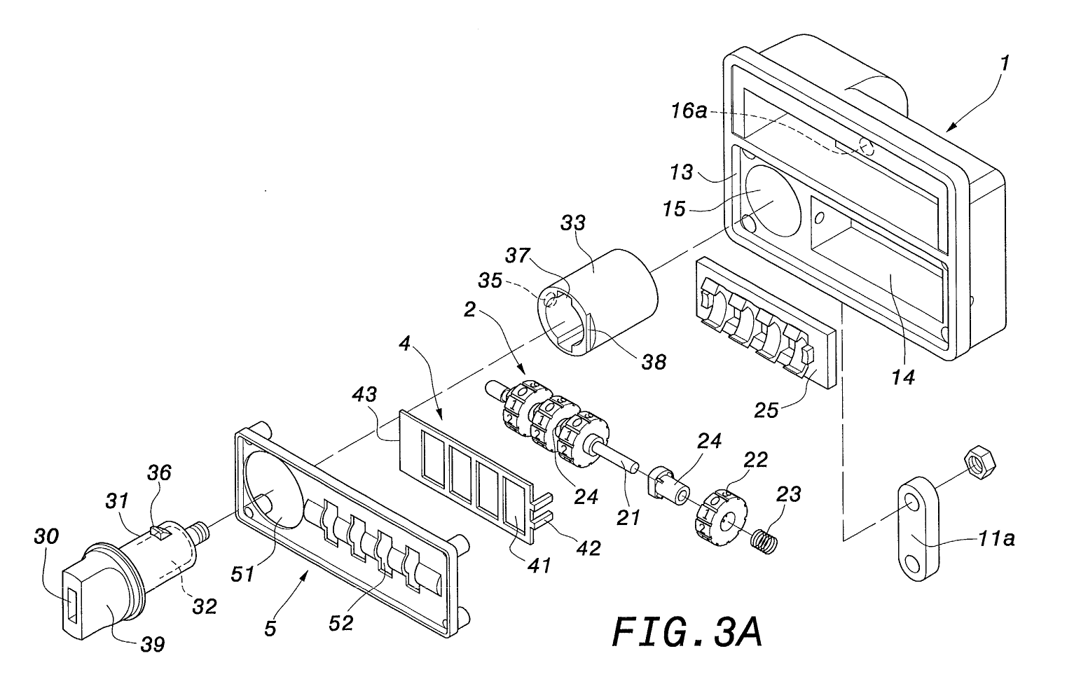

Please refer to FIG. 2 to FIG. 8. The dual mechanism lock of the present invention comprises a lock body 1, lock tongue 11, a combination mechanism 2, a fixing plate 4, a key lock structure 3 and panel 5, wherein an end surface of the lock body has an opening 13, and a first accommodating groove 14 and a second accommodating groove 15 are disposed at the opening 13, and a penetrating hole 16 is disposed at a location proximate to the bottom of an inner peripheral surface of the second accommodating groove 15. In another embodiment shown in FIG. 3A, the penetrating hole 16a is disposed at the inner bottom of the second accommodating groove 15.

The lock tongue 11 as shown in FIG. 3 is inserted through the penetrating hole 16 of the lock body 1, and a fixing groove 12 is disposed on the lock tongue 11, and the lock tongue 11 has a second spring 17 disposed between the end surface connecting the lock body 1 and the bottom surface inside the penetrating hole 16 of the lock body 1, and another embodiment shown in FIG. 3A has a lock tongue 11a in the shape of a rod, and being connected to the outer surface of the penetrating hole 16a.

The combination lock mechanism 2 is disposed in the first accommodating groove 14 of the lock body 1, comprising a fixing plate 4 and a lock core rod 21, the lock core rod 21 is pivotally coupled to a plurality of combination wheels 22, and the top of the lock core rod 21 presses against the peripheral surface of the first accommodating groove 14, and the other end of the lock core rod 21 is coupled to the key mechanism 3, and a first spring 23 is disposed between an end of the lock core rod 21 and an inner side of the first accommodating groove 14.

Each combination wheel 22 is fixed to the lock core rod 21 by a fixing wheel 24, and the combination wheel 22 can move the fixing wheel 24 and produce a coupling or detachment movement to the lock core rod 21. The fixing plate 4 has a plurality groove holes 41 with the same quantity as the combination wheels 22, and each of the groove holes 41 allows part of the combination wheel 22 to pass through, and the fixing plate 4 has a pair of clips 42, and the fixing plate 4 is fixed to the lock core rod by the clips 42 such that the fixing plate 4 moves according to the lock core rod 21, and the elastic latch plate 25 is coupled to the inner bottom of the first accommodating groove 14, and an elastic latch plate 25 latches each combination wheel 22. When the numbers of the combination wheel 22 are matched, the fixing wheel 24 pushes the lock core rod 21 and brings the fixing plate 4 into action.

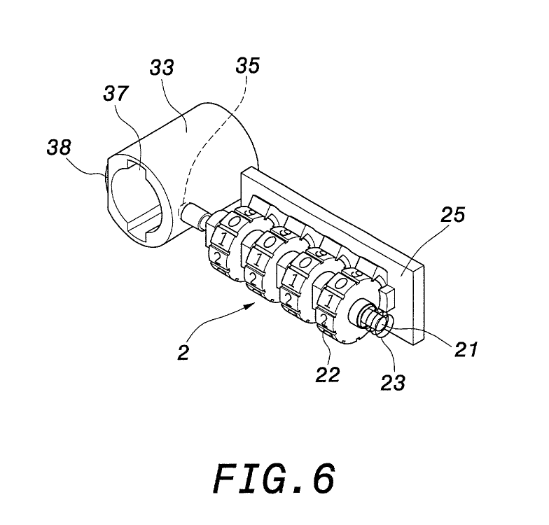

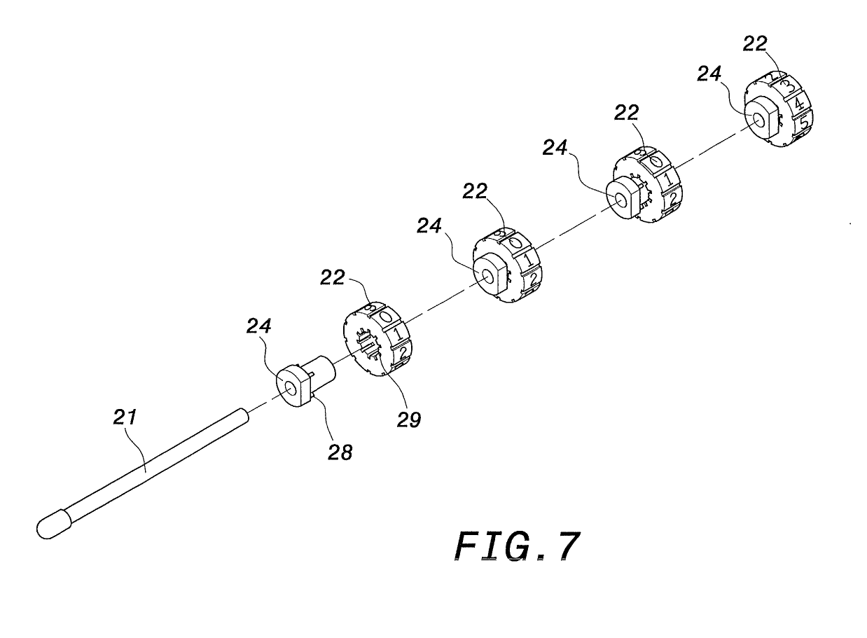

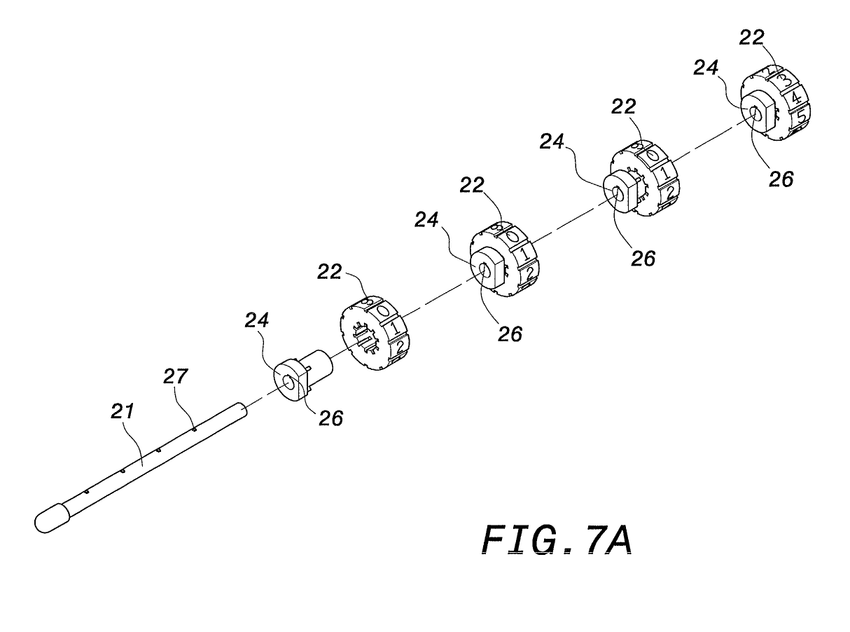

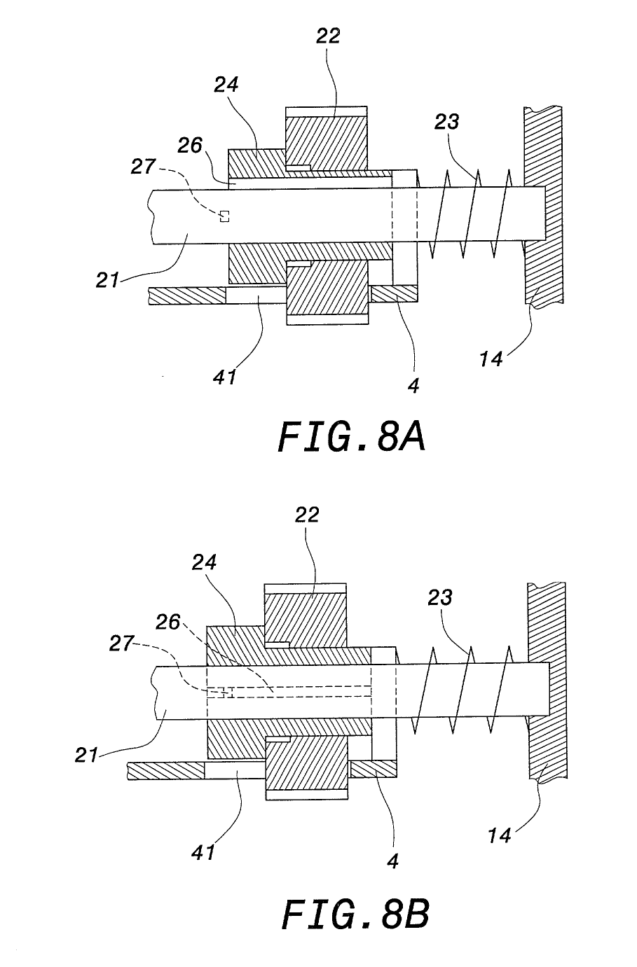

The fixing wheel 24 has a coupling and detachment mechanism, as shown in FIG. 8. When the lock core rod 21 is totally released by the combination wheel 22, the coupling and detachment structure leads the lock core rod 21 to leave a restricted position, and the comcombination wheel 22 to leave the restricted position, too, that allows the combination wheel reset the locking numbers as shown in FIG. 6, wherein another end of the lock core rod 21 presses against the external cylinder 33 and is brought by the inner cylinder in action and rotate in half a circle (as shown in FIG. 6) such that the recession 35 of the external cylinder 33 connecting the lock core rod 21 to release the pressing of the first spring 23 to the lock core rod 21. The coupling and detachment mechanism has a concave groove 26 on the fixing wheel 24, and a plurality of the protruded members 27 on the lock core rod 21 as shown in FIG. 7A. The external peripheral surface of the fixing wheel 24 has an embedded bar 28 corresponsive to each number of the combination wheel 22, and a serrate grove 29 corresponsive to each number disposed on the inner peripheral surface of the combination wheel 22, such that the embedded bar 28 and the serrate groove 29 are coupled.

When the numbers are changed, the embedded bar 28 will rotate with the combination wheel 22 according to different numbers and is fixed to different serrate grooves 29, and it rotates the external cylinder 33 back to the original position, and completes the reset action.

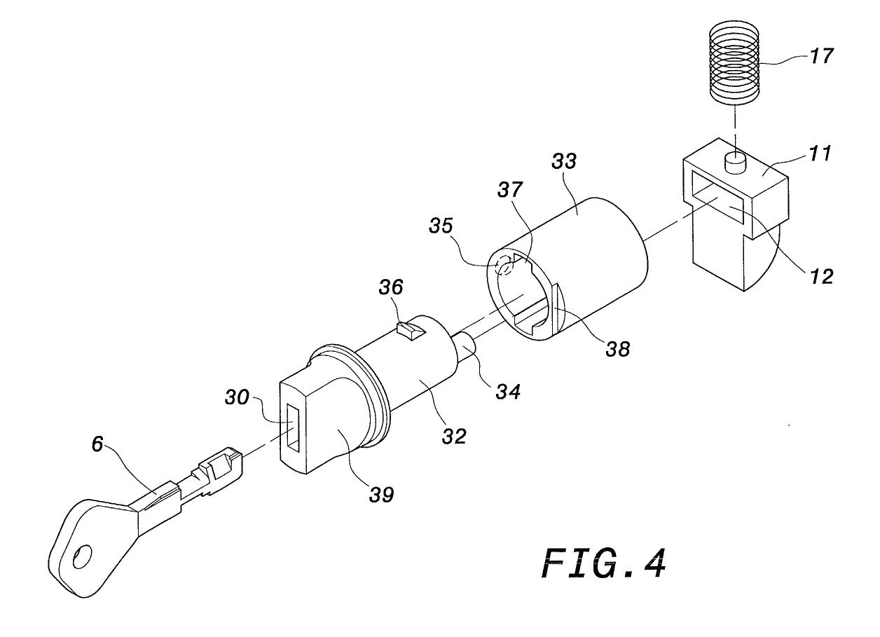

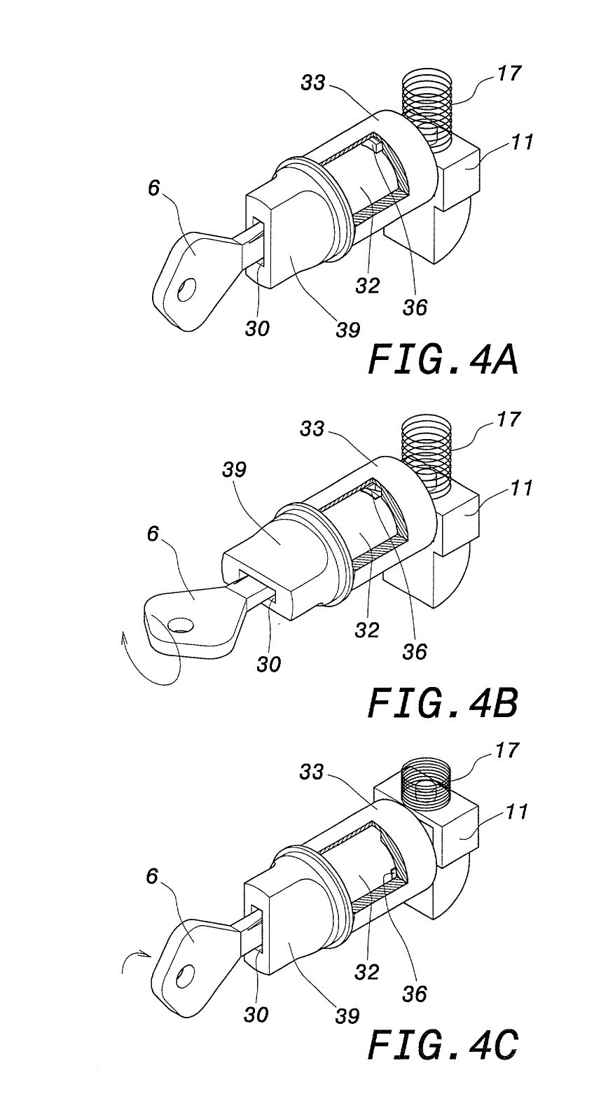

The key lock structure 3 as shown in FIG. 3 and FIG. 4 is disposed in the second accommodating groove 15 of the lock body 1, comprising an internal cylinder 32 and the external cylinder 33, and the external cylinder 33 is a passing-through cylinder, and the inner cylinder 32 passes through the external cylinder 33, and a lock core 31 is in the internal cylinder 32. A protruded member 34 in the inner surface of the internal cylinder 32 such that the protruded member 34 extends into the fixing groove 12 of the lock tongue 11 (as shown in FIG. 3), and a contractible sliding member 36 is protruded form the inner end of the peripheral surface of the internal cylinder 32. The sliding member 36 is brought into action by lock core 31, and at least one guiding groove 37 is disposed in the inner surface of the external cylinder 33 such that the sliding member 36 can enter into the guiding groove 37 as the internal cylinder 32 rotates. The sliding member 36 brings the external cylinder 33 to rotate. A fixing groove 38 is disposed on the peripheral surface of the external cylinder 33, and the fixing groove 38 allows a lateral side 43 of the fixing plate 4 to embed into it. The fixing plate 4 restricts the rotation of the internal cylinder 32 by controlling the coupling and detachment for the fixing groove 38 of the external cylinder 33. In FIG. 3A, the protruded member 34 extends out from the penetrating hole 16a, and produces a locking state between the protruded member 34 and the lock tongue 11a.

A panel 5 covers the lock body 1, having a surface with an opening 13 of a first accommodating groove 14 and a second accommodating groove 15. The panel 5 has a penetrating hole 51, and the penetrating hole 51 allows the internal cylinder 32 to insert into its inner end, and the external end of the internal cylinder 32 has a knob 39. The end surface of the knob 39 has a keyhole 30, and the panel 5 has a plurality of adjusting windows 52 having the same quantity as that of the combination wheels 22, and allows the combination wheel to protrude from the panel.

From FIG. 4A to FIG. 4C, when a key 6 is inserted into the keyhole 30, it brings the lock core 31 of the internal cylinder 32 to rotate, and it will not be the same as shown in FIG. 4A. The sliding member 36 of the internal cylinder 32 is latched to the guiding groove 37 of the external cylinder 33. As the key 6 is rotated to 270 degrees (the state is shown in FIG. 4B, and the rotation is not limited to such angle only), it means that the key brings the lock core to rotate, such that the internal cylinder can be rotated inside of the external cylinder. Then, the rotation of the internal cylinder will not bring the lock tongue 11 to move, and the spring 17 will not have any compression movement. As shown in FIG. 4C, when the internal cylinder 32 is rotated, the internal cylinder 32 directly moves the lock tongue 11 inside the penetrating hole 16 of the lock body 1. Then, the spring 17 will have compression, and thus unlocks the lock. Similarly, when the lock core 31 is locked by the key, the sliding member 36 couples the internal cylinder 32 and the external cylinder 33 into one piece, and the external cylinder 33 restricts the rotation of the internal cylinder 32 and lets the lock tongue 11 eject the spring 17, which will not be retreated. Same mechanical motion is applicable to the embodiment as shown in FIG. 3A, and will not be described any further.

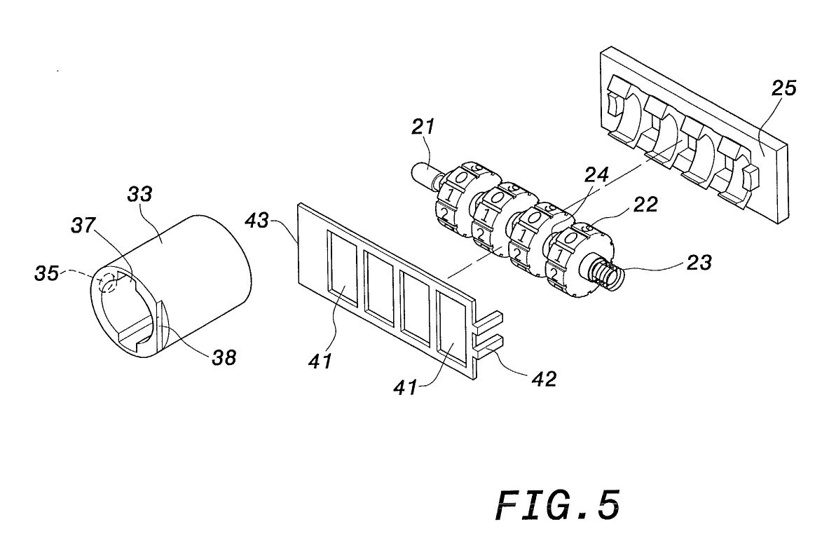

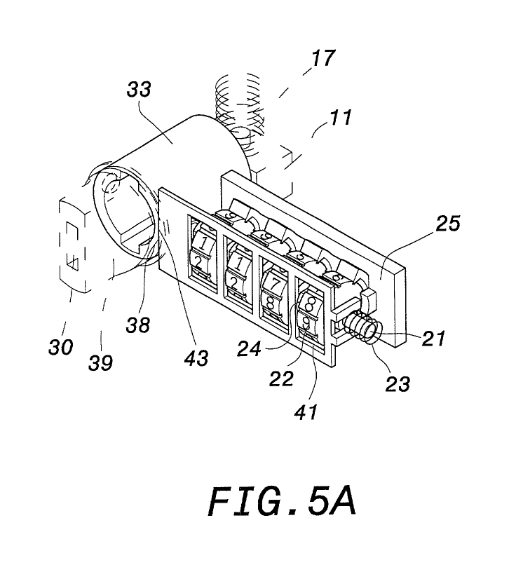

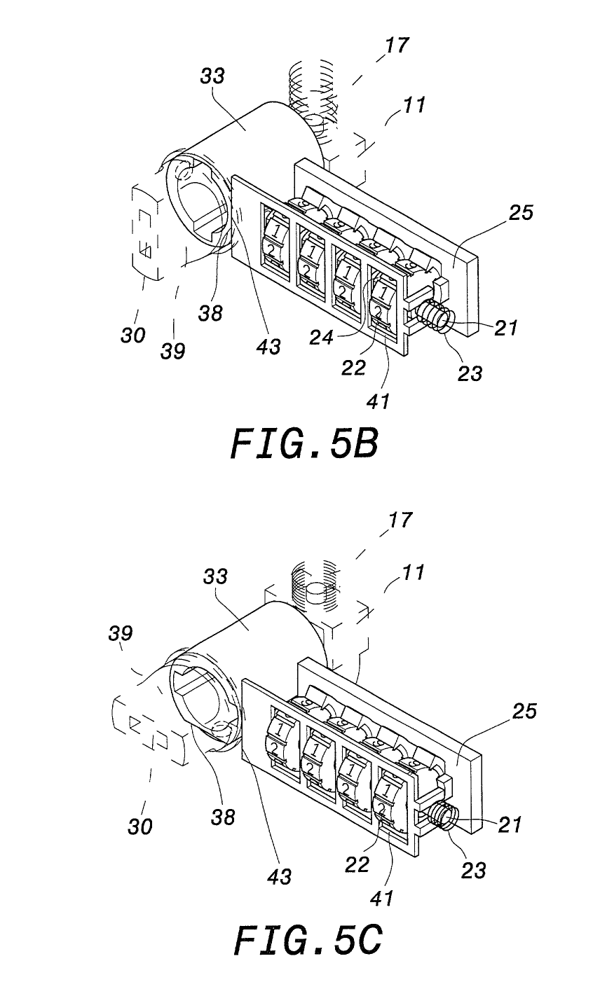

Furthermore, when each combination wheel 22 performs the locking as shown in FIG. 5A, the lock core rod 21 brings the fixing plate 4 to move simultaneously, and lets the fixing plate 4 be latched to the external cylinder 33. At that moment, the numbers of the combination are not in order. For example, if the numbers of the combination are set to be 2222 as shown in FIG. 5B, the combination lock structure 2 releases the latch of the fixing plate 4, and the lock core rod 21 simultaneously brings the fixing plate 4 back into position. Since the movement of the fixing plate 4 is insignificant, it is not easily seen in the figure. However, we can see the change in the numbers, and then the external cylinder 33 can be rotated. Since the external cylinder 33 and the internal cylinder 32 are integrated into one piece, therefore the spring 17 cannot be brought into action as shown in FIG. 5C. The knob 39 brings the internal cylinder 32 to rotate (as describe in the previous section) and moves the lock tongue 11 back into the penetrating hole 16 of the lock body 1, and completes the unlocking action.

In view of the foregoing structure, the design of the fixing plate applied to the present invention can be used together with any kinds of combination locks and key locks. In other words, the fixing plate and the external cylinder work together and completes the locking and unlocking of the combination lock. The external cylinder, the internal cylinder, and the lock core work together to complete the locking and unlocking of the key lock. The two lock mechanisms are independent, and can be implemented individually. In addition, the lock tongue of the present invention can work with the implementation of the internal cylinder of the key lock and can have many different configurations. Similarly, the external look of the lock body can also have different change as shown in FIG. 2. The lock body has an empty groove that enables the user to hold the lock body easily. Furthermore, the combination lock of the present invention also provides the function of resetting numbers to raise the security. Therefore the present invention provides excellent practicability, which is totally different to the prior-art structure.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dual mechanism lock, comprising:
a lock body, having an opening at one end surface, and a first accommodating groove and a second accommodating at a recession of an opening;
a lock tongue, having a fixing groove;
a combination lock structure, being disposed in the first accommodating groove, and having a fixing plate, and a lock core rod, and a plurality of combination wheels pivotally coupled to the lock core rod, and an end of the lock core rod presses against the peripheral surface of the first accommodating groove, and a second spring is disposed between the end surface of the combination wheel on a lateral side of the lock core rod and the inner surface of the first accommodating groove. Each combination wheel is mounted to a fixing wheel on the lock core rod, and the fixing plate has the same number of combination wheel as the groove holes, and part of the corresponsive combination wheel passes through each groove hole, and the fixing plate has a pair of clips for clipping the fixing plate to the lock core rod, and the fixing plate is brought into movement by the lock core rod;
a key lock mechanism, being disposed in the second accommodating groove, and having an internal cylinder and an external cylinder; the external cylinder is penetrative; the internal cylinder passes through the external cylinder; a lock core is in the internal cylinder; the inner end surface of the internal cylinder has a protruded member that extends into a fixing groove of the lock tongue, and a contractible sliding member is disposed and protruded from the inner peripheral surface of the internal cylinder; the sliding member is brought into movement by the lock core, and the inner surface of the external cylinder has at least one guiding groove such that the sliding member can move into the guiding groove with the internal cylinder, and the cylinder drives the external cylinder to move; the peripheral surface of the external cylinder has a fixing groove, which let a lateral side of the fixing plate be embedded;
a panel, covering a lock body which has an opening end surface of a first accommodating and a second accommodating groove, and having a penetrating hole for accommodating the inner end of the internal cylinder, and the external end of the internal cylinder is coupled to a knob, and the end surface of the knob has a keyhole, and having a plurality of adjusting windows having the same quantity as tat of the combination wheels.

2. A dual mechanism lock structure as claimed in claim 1, wherein said second accommodating groove has a penetrating hole at the bottom proximate to the internal periphery of the second accommodating groove, and the lock tongue passes through the penetrating hole of the lock body, and a second spring is disposed between the lock tongue facing the surface end of the lock body and the inner bottom surface of the penetrating hole of the lock body.

3. A dual mechanism lock structure as claimed in claim 1, wherein said first accommodating groove has an elastic latch plate at its inner bottom surface, and each combination wheel is latched by the elastic latch plate.

4. A dual mechanism lock structure as claimed in claim 1, wherein said second accommodating groove has a penetrating hole at the inner bottom of the second accommodating groove, and the penetrating hole allows the protruded member extending outward, and the external end of the protruded member is coupled to the lock tongue, and the lock tongue is in the shape of a plate.

5. A dual mechanism lock structure as claimed in claim 1, wherein said fixing wheel has a coupling and detachment structure, having the resetting and unlocking mechanism for the combination wheel, and a recession being disposed at the opposite direction to the fixing groove on the peripheral surface of the external cylinder, and the recession is disposed to the lock core rod, and the first spring supports and presses against the lock core rod, and a concave groove is disposed on each fixing wheel, and each corresponsive protruded member is disposed on the lock core rod, and the concave groove brings the combination wheel into the protruded member; a plurality of embedded bars with the same quantity as the combination wheels are disposed on the peripheral surface of the fixing wheel, and a plurality of serrate grooves corresponsive to each number of the combination wheel on the peripheral surface of the combination wheel such that the embedded bars and the serrated grooves are coupled.
